(19) United States
(12) Patent Application Publication
(10) Pub. No.: US 2016/0026947 A1
(43) Pub. Date: Jan. 28, 2016

(54) SYSTEMS AND METHODS FOR ORGANIZING METADATA

(71) Applicant: BP3, Austin, TX (US)

(72) Inventors: IVAN S. KORNIENKO, Austin, TX (US); SCOTT L. FRANCIS, AUSTIN, TX (US)

(21) Appl. No.: 14/798,215

(22) Filed: Jul. 13, 2015

Related U.S. Application Data
(60) Provisional application No. 62/029,071, filed on Jul. 25, 2014.

(51) Int. Cl. G06Q 10/06

(52) U.S. Cl. CPC G06Q 10/0633; G06Q 10/06316

(57) ABSTRACT

Embodiments described herein disclose systems and methods for presenting information to a user, wherein the user may view and interact with the information. Embodiments may be configured to present the information in a multilayer pie chart, sunburst, etc., wherein different layers of the chart represent different metadata corresponding to different tasks.

### CROSS-REFERENCE TO RELATED APPLICATIONS

This application claims a benefit of priority under 35 U.S.C. §119 to Provisional Application No. 62/029,071 filed on Jul. 25, 2014 which is fully incorporated herein by reference in its entirety.

### BACKGROUND INFORMATION

1. Field of the Disclosure

Examples of the present disclosure are related to systems and methods for organizing metadata and presenting data to users. More particularly, embodiments disclose organizing related data, filtering the data based on unique metadata values associated with the data, and presenting the data.

2. Background

Workflow management systems are systems that organize and monitor the completion of related tasks, processes, and cases. Workflow management systems allow users to define different workflows for different types of tasks. At each stage in the workflow, individuals or groups are responsible for completing the tasks. Once the task is completed, based on the definitions in the workflow management system, the workflow management system ensures that the individuals responsible for the next tasks are notified.

However, conventional workflow management systems require a user to view each and every task within a given workflow, and conventional workflow management systems require each task within a workflow to display the same metadata to a user.

Yet, the user may desire to view only a given subset of the workflows, such as a subset of given tasks, etc. Additionally, situations may arise where different tasks or groupings of tasks within a workflow have different metadata, and the user may desire to filter and view the tasks based on the metadata associated with different tasks or groups of tasks.

Accordingly, needs exist for more effective and efficient systems and methods for efficiently and effectively presenting data to users.

### SUMMARY

Embodiments described herein disclose systems and methods for presenting data to a user, wherein the user may view and interact with the data. Embodiments may be configured to present the data in a multilayer pie chart, sunburst, etc. (referred to hereinafter collectively and individually as “chart”), wherein different layers of the chart represent tasks filtered via corresponding metadata.

In embodiments, a chart may include at least a first layer, second layer, and third layer. The first layer may be presented as an internal circumference of the chart, the second layer may be presented as a circumference of the first layer, and the third level of data may be presented as a circumference of the second layer.

The first layer of the chart may represent different groups with tasks, data sets, work items, etc. (referred to hereinafter collectively and individually as “tasks”). In embodiments, each of the groups may be associated with a subset of individuals, team, subject, class, etc, wherein the groups may be associated with each other. Each group may have different tasks. A number of tasks associated with each group may vary in quantity, wherein summation of the number of tasks associated with each group may be a total number of tasks.

In embodiments, each task associated with a group may have different sets of metadata and the sets of metadata have different unique values. For example, a first set of metadata may include unique values representing the priority levels of tasks with the following (three) values, “High,” “Medium,” “Low. A second set of metadata include unique values representing the names of users to complete tasks, such as the following (four) values “Robert,” “Jane,” “John,” and “Nancy.”

The first layer of the chart may be configured to present a representation of each group to the user, wherein partitions associated with each group may vary in size based on the number of tasks corresponding to the group. The size of a partition for a group may correspond to a percentage of the number of tasks for the group and the total number of tasks for every group. Therefore, the summation of the sizes of tasks corresponding to each and every group may represent one hundred percent of the total number of tasks.

The second layer of the chart may be associated with partitions of tasks, wherein the tasks are partitioned based on unique values of metadata. The second layer of the chart may be represented as the visualization of tasks based on the set of metadata with the fewest number of unique values. For example, the second layer of the chart may represent tasks based on priority level of the different tasks because the number of unique values (three) associated with priority level is less than the number of unique values (four) associated with the names of users to complete the tasks.

In embodiments, the size of the partition associated unique values of the first set of metadata may vary based on the number of tasks with the unique values. Furthermore, the size of each partition may be based on 1) the size of the partition associated with a task, and 2) a percentage of the tasks with the unique value of metadata and the total number of tasks for the group. Therefore, the summation of the sizes of partitions associated with each task within the second layer may represent one hundred percent of the total number of tasks associated with the group. The size of a first partition within the second layer associated with a first unique value of metadata may be independent of the size of a different partitions within the second layer associated with different unique values of metadata. However, the size of the first partition within the second layer associated with the first unique value may be dependent on the percentage of the number of tasks with the first set of metadata for the group and the total number of tasks for every group.

The third layer of the chart may represent partitions of tasks associated with the group, wherein the partitions are based on a second set of metadata with the second fewest number of unique values. In embodiments, the size of the partitions of tasks within the second layer may vary based on the number of tasks with the unique values for the second set of metadata. The size of the partitions within the second layer may be based on 1) the size of the partition of the corresponding first set metadata, and 2) a percentage of the tasks with the unique value of the second set of metadata and the total number of tasks associated with the second set of metadata. Therefore, the summation of the sizes of partitions in the second layer may represent one hundred percent of the total number of tasks associated with group. The size of a first partition within the third layer associated with the second unique value of metadata may be independent of the size of a different partitions within the third layer associated with the first unique value of metadata. However, the size of the first partition within the third layer associated with the second unique value may be dependent on the percentage of the number of tasks with the first unique value of metadata and the total number of tasks for every group.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a topology for an information visualization system, according to an embodiment.

FIG. 2 depicts an information server, according to an embodiment.

FIG. 3 depicts a method for presenting data to users, according to an embodiment.

FIG. 4 depicts a screenshot of presenting data to a user, according to an embodiment.

FIG. 5 depicts a screenshot of a user selecting a partition of a second layer, according to an embodiment.

FIG. 6 depicts a screenshot a user selecting to view data associated with a third layer of a chart, according to an embodiment.

FIG. 7 depicts a screenshot of a user selecting to view data associated with a partition of the third layer, according to an embodiment.

FIG. 8 depicts a screenshot of a user selecting to view data associated with a partition of the third layer, according to an embodiment.

FIG. 9 depicts a screenshot of a user selecting to view data associated with a partition of the third layer, according to an embodiment.

FIG. 10 depicts a screenshot of a user selecting to view data associated with a partition of the third layer, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments described herein disclose methods and system of data visualization and organization of metadata, wherein different levels of data are presented to a user. The user may be able to filter the levels of data, and interact with the data to be presented with more meaningful data.

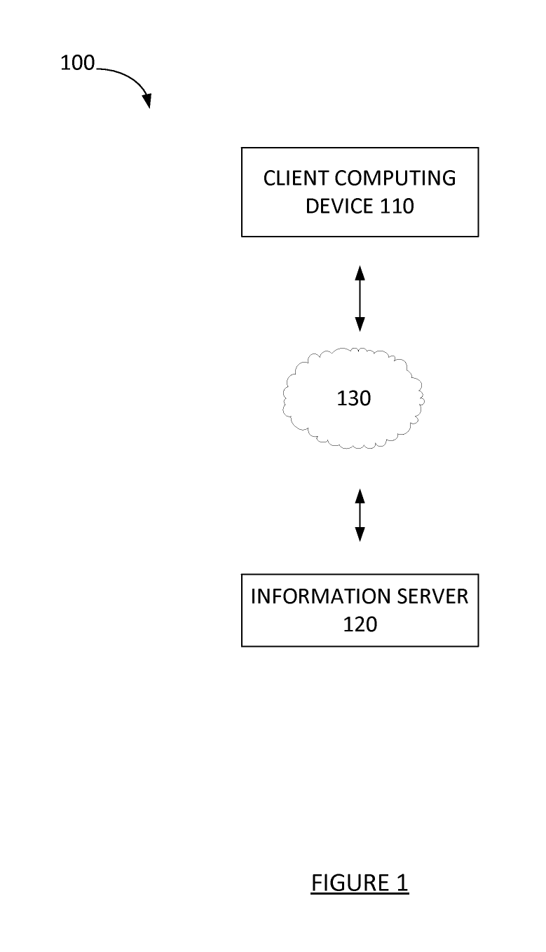

FIG. 1 depicts one embodiment of a topology for an information visualization system 100. Information visualization system 100 may include a client computing device 110, an information server 120, and network 130.

Network 130 may be a wired or wireless network such as the Internet, an intranet, a LAN, a WAN, a NFC network, Bluetooth, universal serial bus, infrared, radio frequency, a cellular network, or another type of network. It will be understood that network 130 may be a combination of multiple different kinds of wired or wireless networks.

Client computing device 110 may be a laptop computer, desktop computer, smart phone, tablet computer, personal data assistant, or any other type of device with a hardware processor that is configured to process instructions and connect to network 130 and/or other forms of networks. Client computing device 110 may include a presentation device, user interface, communication device, and memory device. Although only one client computing device 110 is depicted in FIG. 1, one skilled in the art will appreciate that topology 100 may include a plurality of client computing devices 110.

The presentation device may be configured to present interactive data to a user. The interactive information may be presented as a chart with various layers, within the various layers of the chart may be correlated with one another. Furthermore, the various layers may be partitioned. The sizing of the partitions may be dependent or correlated with data on the same layer and/or higher layer (e.g. the first layer being a higher layer than the second layer). However, the sizing of the partitions may not be correlated or be independent with data on lower layers (e.g. the third layer being a lower layer than the second layer).

The user interface may be a touch screen, a physical keyboard, a mouse, a camera, a video camera, a microphone, etc. configured to receive inputs associated with a user's interactions. The user may utilize the user interface to enter commands to interact with the data. Responsive to the user interacting with the data, the presentation device may present data corresponding to a selected layer and/or further information corresponding to other layers. Additionally, the user interface may be utilized by the user to dynamically generate data associated with the interactive data. For example, the user may utilize the user interface to create, modify, delete, etc. datasets and/or metadata associated with a dataset.

The communication device may be configured to receive data associated with the interactive data presented to the user on presentation device, and transmit data associated with the user's interactions with the user's interactions.

The memory device may be a device that is configured to store data received from information server 120. The memory device may include, but is not limited to cache memory, a hard disc drive, an optical disc drive, and/or a flash memory drive. In embodiments, the memory device may be configured to locally store on client computing device 110 data that is received from information server 120. The information stored within the memory device may be accessed by the presentation device, user interface, and/or the communication device.

Information server 120 may be a computing device, such as a general hardware platform server configured to support mobile applications, software, and the like executed on client computing device 110. It will be appreciated that elements described in relation to information server 120 may be implemented on other system elements, such as client computing device 110. Information server 120 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Information server 120 may include any combination of one or more computer-usable or computer-readable media. For example, information server 120 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

In embodiments, information server 120 may be configured to receive datasets that are associated with each other, wherein the datasets may include first level data, second level data, and third level data. The first level data may be associated with groups, departments, sports leagues, etc., wherein the first level data may represent a broad category of related items. The second level data of a dataset may be subcategories of the first level data, such as tasks within a workflow, goods and/or services carried by a retailer, teams within a sports league, etc. The third level data may be sets of metadata utilized to classify the first level data and/or second level data, wherein the sets of metadata may vary from one first level data group to another and/or one second level data group to another. In embodiments, different sets of metadata may have different unique values based on what the set of metadata represents.

Furthermore, information server 120 may be configured to transmit data to present the first level data, second level data, and third level data. The user may be able to filter the levels of data, and interact with the data to be presented with more meaningful data.

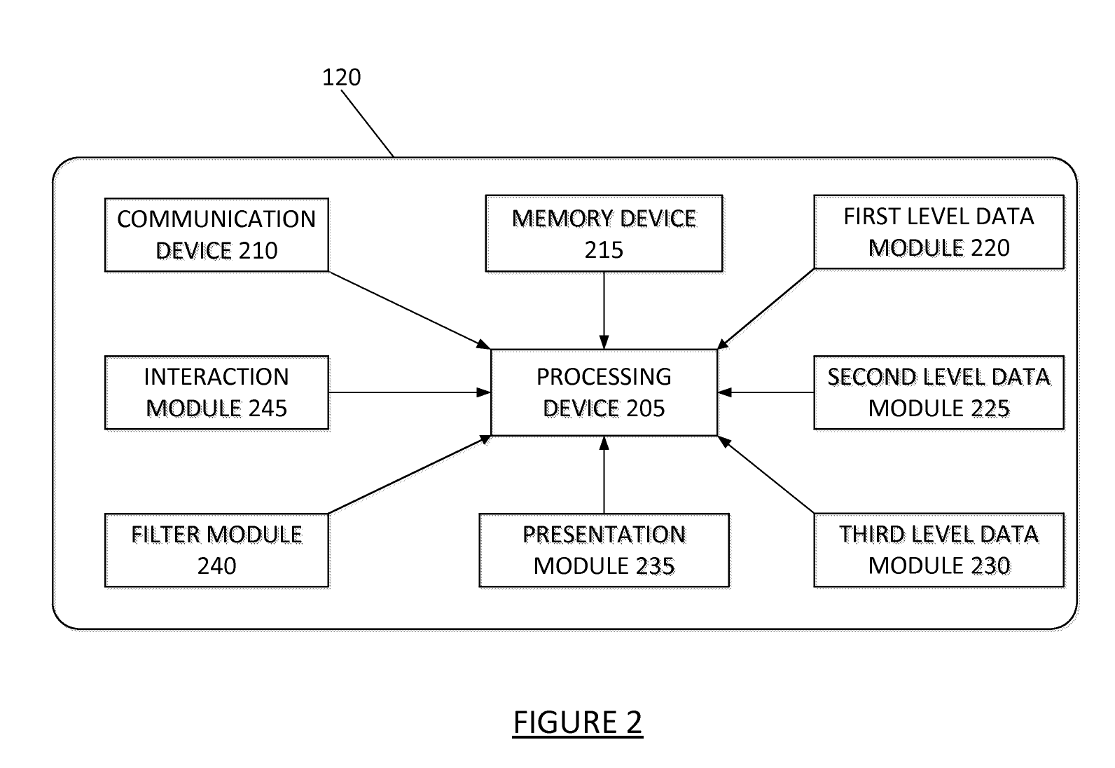

FIG. 2 depicts one embodiment of information server 120. Information server 120 may include a processing device 205, a communication device 210, memory device 215, first level data module 220, second level data module 225, third level data 230, presentation module 235, filter module 240, and interaction module 245.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of information server 120 or software associated with other elements of information server 120.

Communication device 210 may be a device that allows information server 120 to communicate with another device over network 130. Communication device 210 may include one or more wireless transceivers for performing wireless communication and/or one or more communication ports for performing wired communication. In implementations, communication device 210 may be configured to communicate data over a plurality of different standards and/or protocols.

Memory device 215 may be a device that stores data generated or received by information server 120. Memory device 215 may include, but is not limited to a hard disc drive, an optical disc drive, and/or a flash memory drive. In embodiments, memory device 215 may be configured to store information received from client computing device 110. The information stored within memory device 215 may be accessed by processing device 205, communication device 210, and/or modules 220, 225, 230, 235, 240, 245.

First level data module 220 may be a hardware processing device configured to receive first level data from client computing device 110. The first level data may define a high level category of related groups or categories of datasets (referred to hereinafter collectively and individually as “group”). For example, different groups may be departments to complete a workflow, retailers, sports leagues, etc. In embodiments, the groups may or may not be related with each other. For example, groups may be departments within a company that are required or desired to complete tasks for a project, wherein each department may be assigned a varying number of tasks. Or, a group may be associated with unassigned tasks. The first level data may be dynamically generated by a user of client computing device 110, wherein additional first level data may be generated at any desired point in time.

Second level data module 225 may be a hardware processing device configured to receive second level data from client computing device 110. The second level data may be subcategories, sub-classifications, subgroupings, etc. of data associated with the first level data. Each group within the first level of data may have a number of subcategories, tasks, items, etc. (referred to hereinafter collectively and individually as “tasks”), and each task may have a unique name. In embodiments, different groups may have different numbers of tasks. For example, a first group associated with a human resources department may have five tasks to complete, a second group associated with an engineering department may have ten tasks to complete, etc. The second level data may be dynamically generated by a user of client computing device 110, wherein additional second level data may be generated at any desired point in time.

Third level data module 230 may be a hardware processing device configured to receive third level data from client computing device 110. The third level data may be metadata associated with the groups and/or tasks, and each task may have different metadata, wherein the different metadata may have different numbers of unique values. For example, a first set of metadata may include unique values representing the priority levels of tasks with the following (three) values, “High,” “Medium,” “Low. A second set of metadata include unique values representing the names of users to complete tasks, such as the following (four) values “Robert,” “Jane,” “John,” and “Nancy.” The third level data may be dynamically generated by a user of client computing device 110, wherein additional third level data may be generated at any desired point in time.

Presentation module 235 may be a hardware processing device configured to transmit data to be displayed on client computing device 110. The transmitted data may be configured to be presented in a multilayer pie chart, sunburst, etc., wherein the layers represent different data. The chart may include at least a first layer and a second layer. Presentation module 235 may be configured to present the first, second, and/or third layers of data associated with each group simultaneously, or presentation module 235 may be configured to present first, second, and/or third layers of data associated with only a single group and/or task.

The first layer may be represented as an internal circumference of the chart, and may include partitions of the first level of data, wherein each group may have its own partition. The sizing of the partitions within the first layer may be based on the number of tasks associated with each group. The sizing of a group may represent a percentage of the number of tasks associated with the group from the total number of tasks associated with every group. Therefore, the partitions of every group may add up to be one hundred percent (e.g. three hundred sixty degrees) of the tasks.

The second layer may be a second circumference of the chart, and be positioned adjacent to the first layer. The second layer may include partitions representing second level data. The number of partitions of second level data may be based on the number of unique values of metadata associated with the second level data. One skilled in the art will appreciate that each group may have a different number of partitions because the metadata associated with each group may be different.

The partitions within the second layer may be determined based on the metadata with the fewest number of unique values, wherein each partition within the second layer may represent a unique value of metadata corresponding to the second level data. The partitions within the second layer may be configured to align with a corresponding partition of the first level data. The sizing of the partitions within the second layer may be based on 1) the size of the partition of the corresponding group in the first layer, 2) the number of unique values of metadata associated with the task, and 3) the total number of tasks associated with the corresponding group.

Embodiments may include further layers, wherein the ordering of the further layers are based on the metadata with the next fewest number of unique values, and the partitions of the further layers may correspond to the number of tasks associated with the unique metadata values. The partitions of the further layers may be configured to align with the corresponding partitions of the adjacent layer.

Filter module 240 may be a hardware processing device configured to determine which partitions of the second level of data should be represented in the second layer of data. Filter module 240 may determine which sets of metadata may form the partitions of the second layer based on the metadata that has the fewest number of unique values.

For example, a group may include tasks, and the tasks may have different metadata. A first set of metadata may have three unique values associated with the priority level of the task (e.g. “High,” “Medium,” “Low”), a second set of metadata may have four unique values associated with the employee to complete a task (e.g. “Robert,” “Jane,” “John,” and “Nancy), and a third set of metadata may have five unique values associated with a completion data of a task (e.g. “Jan. 1, 2014,” “Jan. 2, 2014,” Jan. 3, 2014,” “Jan. 4, 2014,” “Jan. 5, 2014”).

Filter module 240 may be configured to determine which of the sets of metadata have the fewest number of unique values, and form partitions of the second layer for each unique value for the determined set of metadata. Filter module 240 may determine different partitions within the second layer for different groups, because different groups may have different sets of metadata. Filter module 240 may also be configured to partition further layers of the chart.

Interaction module 245 may be configured alter the presentation of the levels of data to the user based on the user's interactions. The user may interact with the data by performing actions to select a group, a partition corresponding to a group, sets of metadata, etc.

In embodiments, responsive to the user performing actions to select a partition corresponding to a layer of the chart, interaction module 245 may alter what data is presented to the user. For example, initially a user may be presented with a chart including a first layer of data with partitions corresponding to groups, and a second layer of data with partitions corresponding to metadata associated with the tasks, wherein the partitions are of the second layer are aligned with a corresponding partition of the second layer.

Responsive to the user performing actions to select a first partition within the second layer, interaction module 245 may alter the chart to only include data associated with the selected partition and the corresponding task. More specifically, interaction module 245 may dynamically remove the first layer of data, causing the second layer of data to be the internal circumference of the chart. Interaction module 245 may also change the depicted layers, wherein further layers of data including partitions may be presented to the user. The partitions of the further layers may be aligned with a corresponding partition of the second layer, which is the new internal circumference of the chart. Accordingly, interaction module 245 may be configured to dynamically drill down into the chart to present more meaningful data to the user.

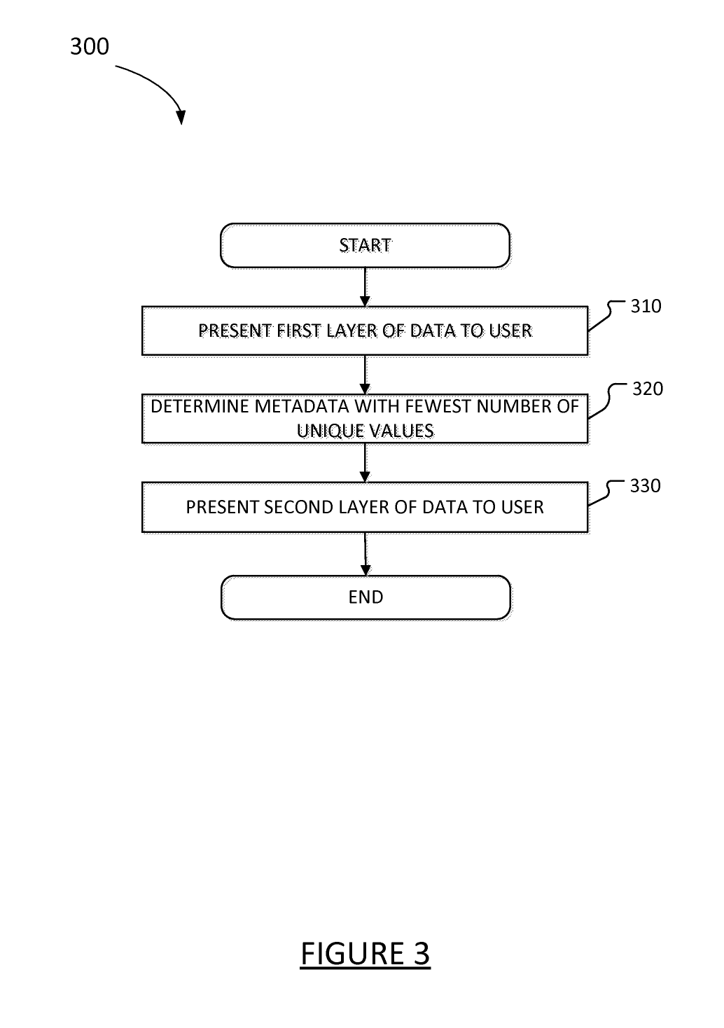

FIG. 3 illustrates a method 300 for presenting data to users. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a solid-state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At operation 310, a first layer of data may be presented to a user. The first layer of data may be presented as a partitioned, inner circumference of a sunburst chart. Each partition of the inner circumference may be associated with first level data, such as groups, departments, teams, or any other datasets that may be categorized. The sizing of the partitions may be based on a number of second level data (e.g. subcategories) associated with the first level data. For example, the second level data may correspond with tasks a group must complete. Operation 310 may be performed by a first level data module that is the same as or similar to first level data module 220, in accordance with one or more implementations.

At operation 320, the third level data (e.g. metadata) with the fewest number of unique values associated with the second level data may be determined. The metadata with the fewest number of unique values may be determined for each set of second level data, wherein the metadata with the fewest number of unique values may be determined by comparing the number of unique values associated with set of metadata. Operation 320 may be performed by a filter module that is the same as or similar to filter module 240, in accordance with one or more implementations.

At operation 330, a second layer of data may be presented to a user. The second layer of data may be presented as a partitioned, second circumference of a sunburst chart being positioned adjacent to the first layer. The second layer of data may include partitions representing second level data, wherein the number of partitions associated with a group may be based on the number of unique values of values associated with the set of metadata determined at operation 320. Each partition within the second layer may correspond to the number of second level data associated with a unique value for the determined set of metadata. Operation 330 may be performed by a second level data module that is the same as or similar to second level data module 225, in accordance with one or more implementations.

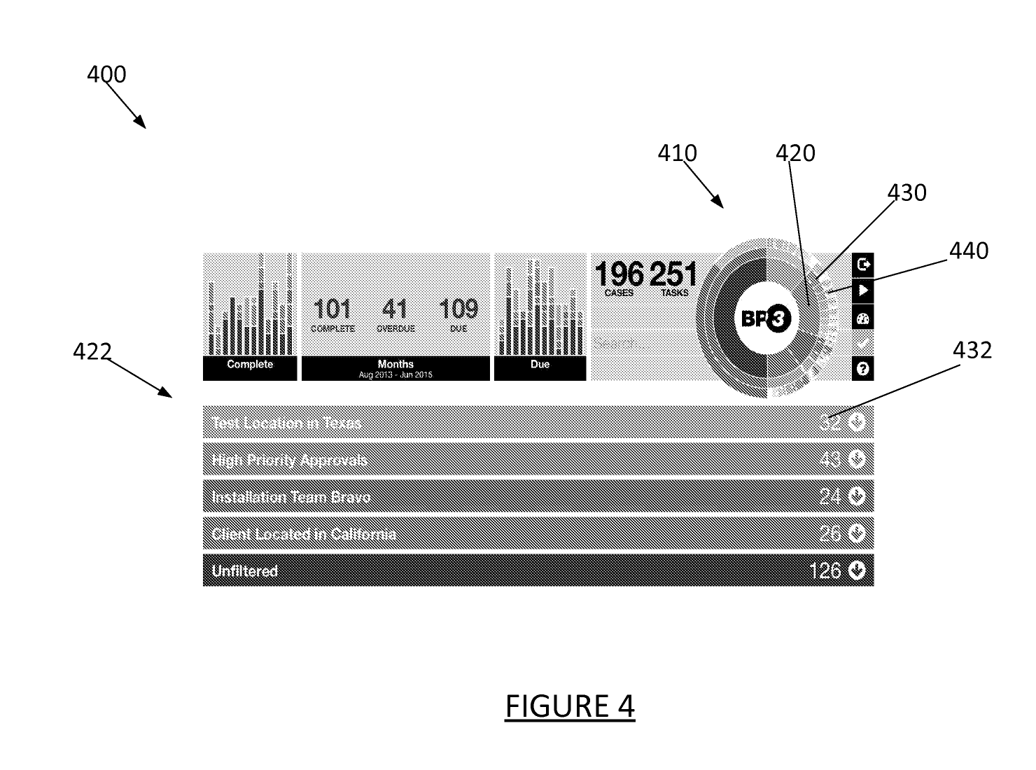

FIG. 4 depicts one embodiment of a screenshot 400 depicting presenting data to a user. As depicted in FIG. 4, chart 410 may include first layer 420, second layer 430, and third layer 440.

First layer 420 may include a plurality of partitions of first level datasets, wherein each partition corresponds to a different set of first level data 422. The sets of first level data 422 depicted in first layer 420 may be presented below chart 410, wherein each entry within the set may include a name and a number. The number associated with each entry of first level data 422 may be associated with the number of second level datasets 432 associated with the corresponding first level dataset 422.

Each partition of first layer 420 may be sized to represent a percentage of the number of second level datasets 432 associated with a corresponding first level dataset 422 and the total number of second level datasets 432 associated with every first level dataset 422 represented in chart 410.

Second layer 430 may include partitions of second level datasets 432 that are aligned with a corresponding first level dataset 422. The partitions of the second layer 430 may be based on the metadata associated with the second level dataset 432, wherein the partitions within second layer correspond to the set of metadata with the fewest number of unique values.

Each partition of second layer 430 may be sized based on 1) the size of a corresponding partition within the first layer 420, 2) the number of unique values associated with the set of metadata, and 3) the percentage of the second level datasets with a given value and the total number of second level datasets associated with the corresponding first level dataset 422.

Third layer 440 may include partitions of second level datasets 432 that are aligned with a corresponding second level dataset. The partitions of the third layer 440 may be based on the metadata associated with the second level datasets 432, wherein the partitions within third layer correspond to the set of metadata with the second number of unique values. Therefore, the third layer 440 may be utilized to further break down, delineate, classify, etc. the data depicted in the chart 410 based on a different category of metadata that is depicted in the second layer 430.

Each partition of third layer 440 may be sized based on 1) the size of a corresponding partition within the second layer 430, 2) the number of unique values associated with the set of metadata in the third layer, and 3) the percentage of the second level datasets 432 with a given value and the total number of second level datasets 432 associated with the corresponding first level dataset 422.

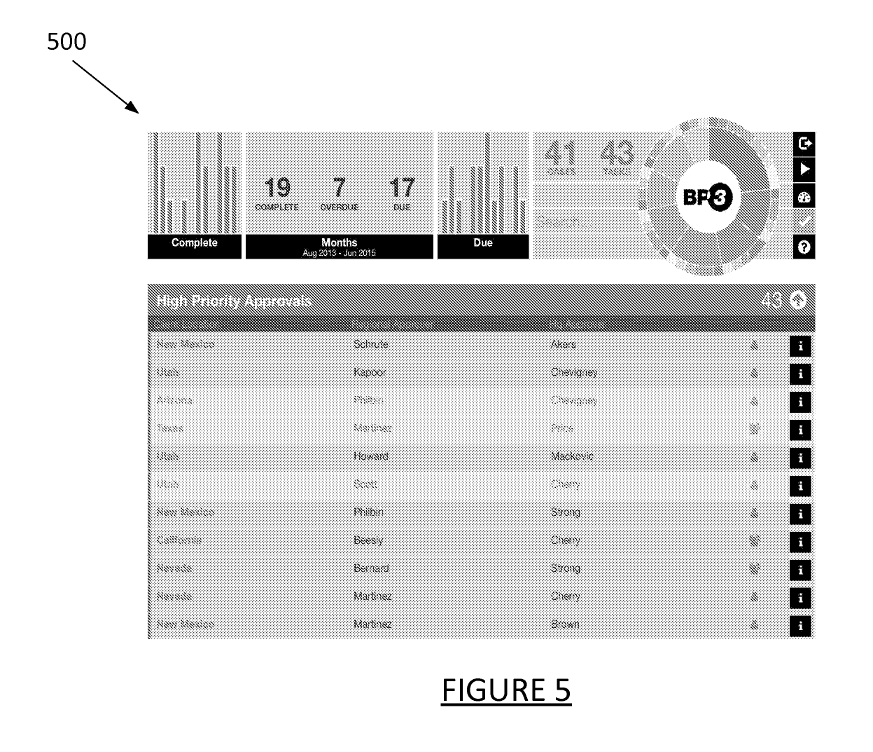

In embodiments, a user may be able to perform actions to interact with the different layers and/or partitions of data. For example, FIG. 5 depicts one embodiment of a screenshot 500 of a user selecting a partition of second layer 430 associated with “High Priority Approvals.”

Chart 510 may represent a depiction of second layer 430 of chart 400, wherein the internal layer may be based on “Client Location” because there may be fewer unique values associated with “Client Location” than “Regional Approver” or “Hq Approver.” Each of the partitions depicted in the internal layer of chart 510 may represent a different client location, and the second layer of chart 510 may represent a different regional approver, because the regional approver set of metadata may have fewer unique values than Hq approver. The second layer of chart 510 may indicate which regional approvers have tasks associated with different client locations.

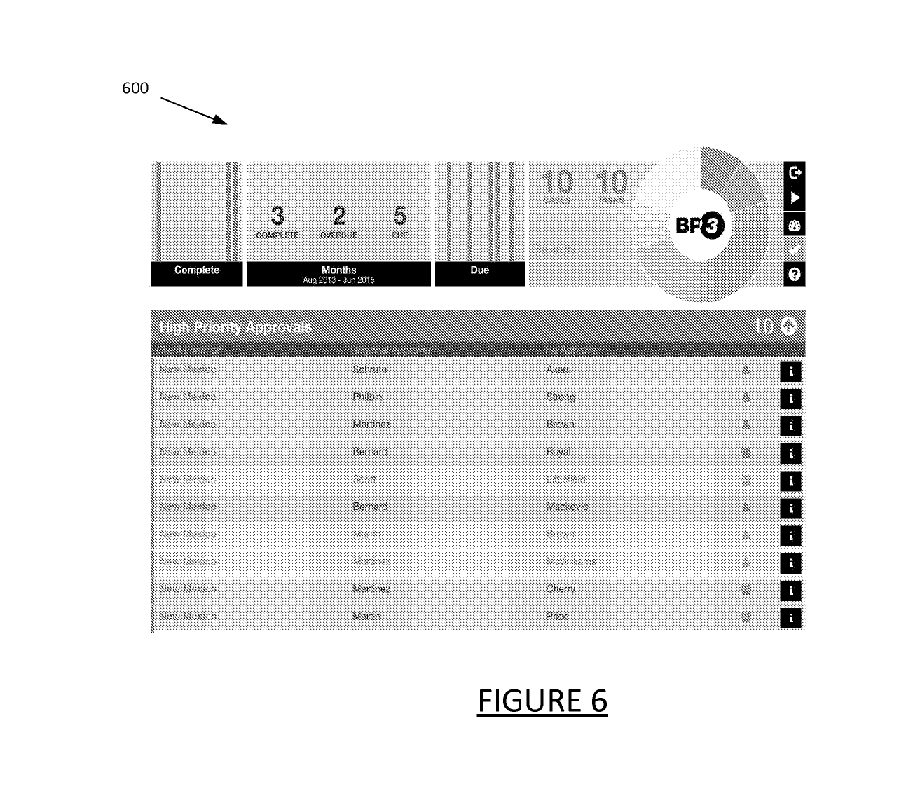

FIG. 6 depicts one embodiment of a screenshot 600 of a user selecting to view data associated with third layer 440 of chart 410. The selection of third layer 430 may identify second level datasets (e.g. High Priority Approvals) with the unique value (e.g. New Mexico) for metadata (e.g. Client Location).

Accordingly, the original third layer 440 in chart 410 may be presented to the user as a new chart including only the information with the selected unique value for metadata. The new chart may have partitions that correspond to different regional approver, wherein the sizing of the partitions is based on the number of tasks assigned to the regional approver for the client location.

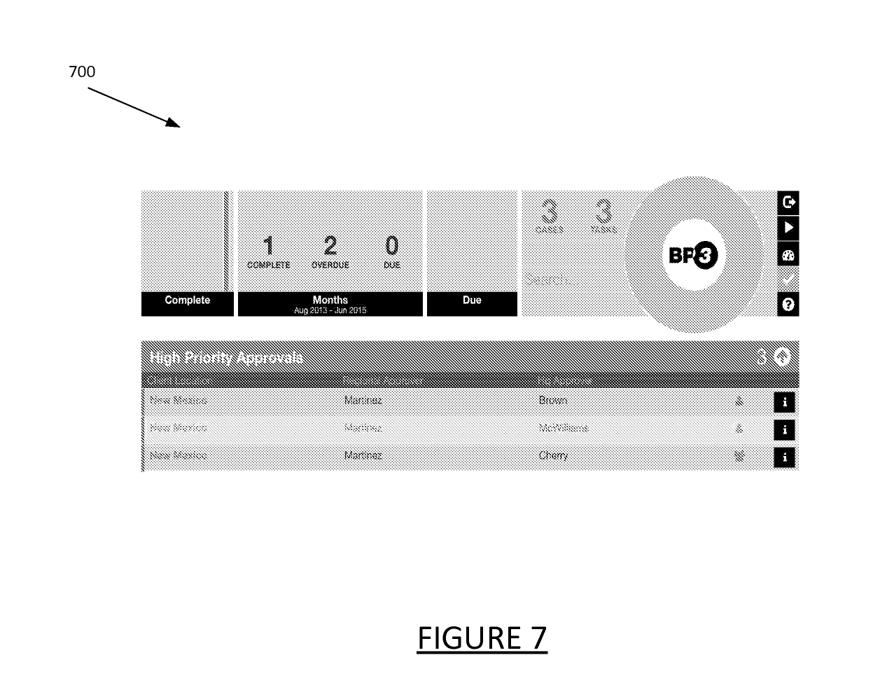

FIG. 7 depicts one embodiment of a screenshot 700 of a user selecting to view data associated with a partition of the third layer 430. The selected partition may be associated with second level datasets with the same unique value “Martinez” and “New Mexico” of metadata associated with “Regional Approver” and “Client Location,” respectively.

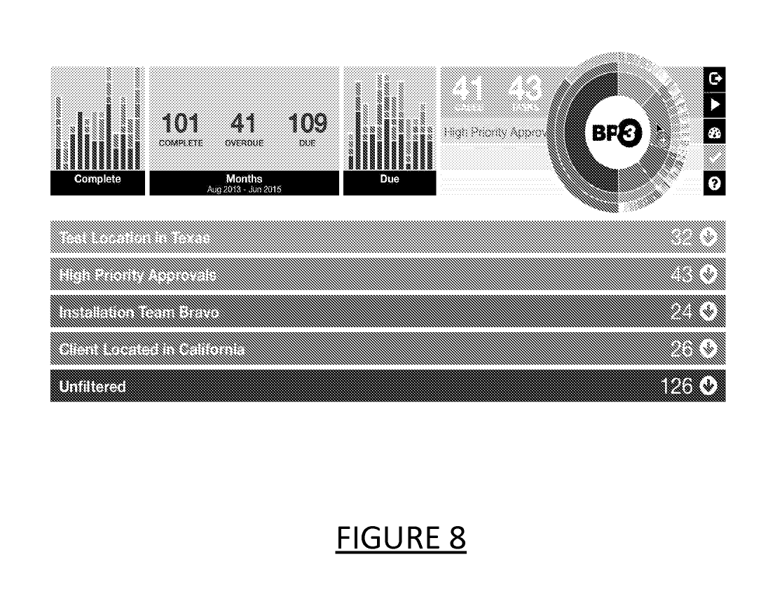

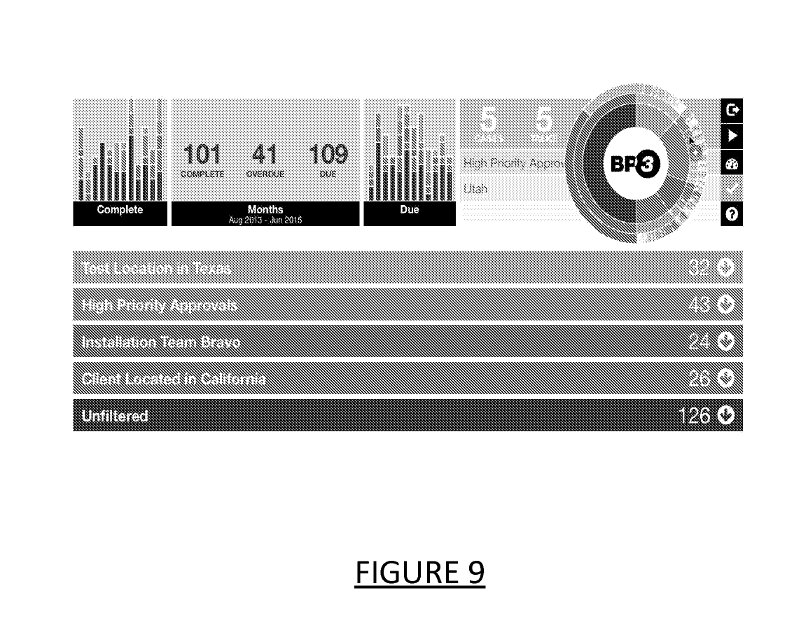

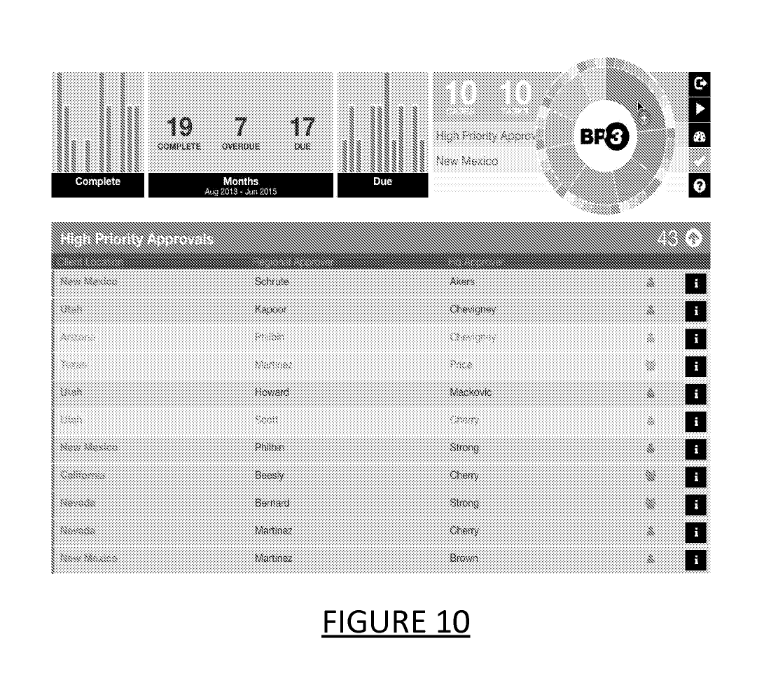

FIGS. 8-10 depicts various screenshots of implementations of systems and methods disclosed herein.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system for organizing and presenting metadata, the system comprising:
a first level hardware device configured to receive first level data, the first level data defining high level categories of related groups;
a second level hardware device configured to receive second level data indicating tasks associated with the first level data, wherein each of the groups have different tasks, and each task has a unique identifier, wherein each unique identifier having metadata with different numbers of unique values; and
a display configured to present a first layer represented as an internal circumference of a chart, and a second layer being positioned adjacent to the first layer, the first layer being associated with the first level data, and the second layer being associated with the second level data.

2. The system of claim 1, wherein partitions associated with each of the groups in the first layer is based on a number of tasks associated with each of the groups.

3. The system of claim 2, wherein a first size of a first partition within the first layer represents a percentage of a first number of tasks associated with a first group and a total number of tasks associated with each of the groups.

4. The system of claim 1, wherein a number of partitions within the second layer is based on a number of the unique values of metadata associated with the task.

5. The system of claim 4, wherein the second layer for each group is selected based on the metadata having the fewest number of unique values.

6. The system of claim 5, wherein partitions associated with the tasks in the second layer align with a corresponding group.

7. The system of claim 6, wherein a size of the partitions within the second layer is based on a size of a partition of the corresponding group in the first layer, the number of unique values of metadata associated with the task, and a total number of tasks associated with the corresponding group.

8. The system of claim 7, wherein each of the partitions in the second layer associated with the corresponding group is associated with a different unique identifier.

9. The system of claim 7, wherein a first group has a first set of partitions associated with a first set of tasks, and a second group has a second set of partitions associated with a second set of tasks.

10. The system of claim 1, further comprising:
a third level hardware device configured to receive third level data, the third level data being the metadata associated with the unique values associated with the tasks, wherein different metadata have different number of unique values, wherein the display is configured to present a third layer, the third layer being positioned adjacent to the second layer, and the third level representing the third level data.

11. A method for organizing and presenting metadata, the system comprising:
receiving first level data defining high level categories of related groups;
receiving second level data indicating tasks associated with the first level data, wherein each of the groups have different tasks, and each task has a unique identifier, wherein each unique identifier having metadata with different number of unique values; and
presenting a first layer represented as an internal circumference of a chart, and a second layer being positioned adjacent to the first layer, the first layer being associated with the first level data, and the second layer being associated with the second level data.

12. The method of claim 11, further comprising:
generating partitions associated with each of the groups in the first layer based on a number of tasks associated with each of the groups.

13. The method of claim 12, wherein a first size of a first partition within the first layer represents a percentage of a first number of tasks associated with a first group and a total number of tasks associated with each of the groups.

14. The method of claim 11, further comprising:
generating a number of partitions within the second layer based on a number of the unique values of metadata associated with the task.

15. The method of claim 14, further comprising:
selecting the metadata representing in the second layer for each group based on the metadata having the fewest number of unique values.

16. The method of claim 15, further comprising:
aligning partitions associated with the tasks in the second layer a corresponding group.

17. The method of claim 16, wherein a size of the partitions within the second layer is based on a size of a partition of the corresponding group in the first layer, the number of unique values of metadata associated with the task, and a total number of tasks associated with the corresponding group.

18. The method of claim 17, wherein each of the partitions in the second layer associated with the corresponding group is associated with a different unique identifier.

19. The method of claim 18, wherein a first group has a first set of partitions associated with a first set of tasks, and a second group has a second set of partitions associated with a second set of tasks.

20. A method for organizing and presenting metadata, the system comprising:
receiving first level data defining high level categories of related groups;
receiving second level data indicating tasks associated with the first level data, wherein each of the groups have different tasks, and each task has a unique identifier, wherein each unique identifier having metadata with different number of unique values; and
receiving third level data being the metadata associated with the unique values associated with the tasks, wherein the display is configured to present a third layer, the third layer being positioned adjacent to the second layer, and the third level representing the third level data.
presenting a first layer represented as an internal circumference of a chart, the first layer being associated with the first level data, wherein a first group within the first layer has a first set of partitions associated with a first set of tasks, and a second group within the first layer has a second set of partitions associated with a second set of tasks;
generating partitions associated with each of the groups in the first layer based on a number of tasks associated with each of the groups, wherein a first size of a first partition within the first layer represents a percentage of a first number of tasks associated with a first group and a total number of tasks associated with each of the groups;
presenting a second layer being positioned adjacent to the first layer, the second layer being associated with the second level data;
selecting the metadata representing in the second layer for each group based on the metadata having the fewest number of unique values;
generating a number of partitions within the second layer based on a number of the unique values of metadata associated with the task, wherein each of the partitions associated with the tasks in the second layer is aligned with a corresponding group, wherein a size of the partitions within the second layer is based on a size of a partition of the corresponding group in the first layer, the number of unique values of metadata associated with the task, and a total number of tasks associated with the corresponding group;
presenting a third layer being positioned adjacent to the second layer, the third layer being associated with the third level data.
